(19) United States
(12) Patent Application Publication
(10) Pub. No.: US 2008/0320071 A1
(43) Pub. Date: Dec. 25, 2008

(54) METHOD, APPARATUS AND PROGRAM PRODUCT FOR CREATING A TEST FRAMEWORK FOR TESTING OPERATING SYSTEM COMPONENTS IN A CLUSTER SYSTEM

(75) Inventors: Curtis L. Hoskins, Poughkeepsie, NY (US); Anthony F. Pioli, Woodstock, NY (US); Hypatia Rojas, Lancaster, PA (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/766,134

(22) Filed: Jun. 21, 2007

(51) Int. Cl. G06F 15/16

(52) U.S. Cl. 709/202

(57) ABSTRACT

A method, apparatus and program product include an Automatic Testing System for creating a test framework for testing operating system components. The Automatic Testing System resides on a server and includes a master driver which assists in creating test cases and scenarios. The Automatic Testing System issues commands to distribute execution to one or more remote client machines in a cluster through, for instance, an external remote shell program. Results of the command are retrieved, as though it was invoked on the machine directly. The logic and parameters needed to run the test scenarios are stored in a database accessible on the web, and test results are compiled and stored in the database to be sent to any designated test customer.

### FIELD OF THE INVENTION

This invention relates to testing software, and particularly to testing operating system components in a cluster system.

### BACKGROUND OF THE INVENTION

A cluster system is typically described as a type of parallel or distributed system that consists of a collection of interconnected computers, and is used as a single, unified computing resource. The functionality of either an individual computer, or cluster, comprises groups of related functions (combination of Operating System (OS) and its interaction with other components called middleware).

Each computer comprises an OS (either the same, or mixed) with groups of related functions referred to herein as components. The specific components that are tested, is the OS and what we consider to be middleware. The problem is how to test the OS/middleware. A solution is to utilize a set of established user applications to access the components of an operating system. Application programs will ensure that the OS system components, when called upon, execute in an intended manner.

Once the set of components of the OS is established, a variety of methods based upon combinations of parameter usages, (usage of the application programs), will allow the creation of testcases.

This solution can become cumbersome if you must test these components on multiple hardware platforms. Also the frequency of changes with respect to the software components (OS and middleware), now requires that some kind of test frame work be established, that will allow the methodical creation of new testcases, and workloads to be incorporated into a test case suite.

A test automation framework would allow for a more methodical approach that could be used in a cluster. A solution STAF (Software Testing Automation Framework) is an open source automation framework designed, on the idea of reusable services, which will make it easier to create test cases and test environments, while providing an infrastructure that makes it easier to manage tests and test environments. However, when faced with multiple hardware platforms and multiple OS, there several problems need to be solved.

A test framework on multiple OS/hardware platforms must be provided. However, multiple releases of OS and middleware make it difficult to constantly modify the test framework. As a result, more time is spent on the test framework instead of the actual test case creation and execution. Even when the framework is finally ready for a platform, installing the test framework on all of the nodes becomes cumbersome, and error prone. Installing the test framework on any given compute node is, by definition, an added resource. This has the potential to change the environment of the system under test, i.e. not a true customer environment.

Sharing test automation activities must be provided to allow test reuse, and testcase creation. In order to share test activities, a method must be in place that will allow access to an individual tests suit, while having access to the global community test suite. To create new testcases based on pre existing tests is ideal, but one must have access to them.

It must be determined how to allow the test frame work to be used for virtually any set of software components. As the OS and hardware change, so will the middleware. A method must be in place that will allow new/modified Application programs to be created without any significant change to the test framework. Only the creation and modification of testcases should be done, not time spent on modifying the test framework.

U.S. Patent Application Publication 2002/0156608 A1 published Oct. 24, 2002 by Armbruster et al. for INTEGRATED TESTCASE LANGUAGE FOR HARDWARE DESIGN VERIFICATION discloses a itestcase language for verifying hardware designs. Each of the elements improves the management of test cases and their execution.

U.S. Patent Application Publication 2005/0125187 A1 published Jun. 9, 2005 by Pomaranski et al. for SYSTEM AND METHOD FOR TESTING AN INTERCONNECT IN A COMPUTER SYSTEM discloses an operating system, a first component that comprises a first test module, a second component that comprises a second test module, and an interconnect coupling the first component and the second component is provided. The first test module is configured to provide a first test pattern to the second test module on the interconnect in response to a first signal from the operating system.

U.S. Pat. No. 4,803,683 issued Feb. 7, 1989 to Mori et al. for METHOD AND APPARATUS FOR TESTING A DISTRIBUTED COMPUTER SYSTEM discloses a distributed processing system where a series of processes are carried out by distributed processors connected through a network without provision of a control processor which control the overall system. An arbitrary processor generates test information and the processors, each having a memory for storing a program to be tested, decide whether or not the program is to be test-run in accordance with the test information and, if test-run is carried out, sends out the result of the test-run program into the network when necessary.

U.S. Pat. No. 4,953,096 issued Aug. 28, 1990 to Wachi et al. for TEST METHOD AND APPARATUS FOR DISTRIBUTED SYSTEM discloses in a distributed system having a plurality of processors connected to a common transmission line, each processor comprising means for registering erroneous programs within the processor, and means for changing modes, so that the program is diagnosed on the basis of a processed result of data accepted from the transmission line and is registered in the erroneous program registration means if it is erroneous. The mode change means changes over the test mode and the on-line mode by reference to the erroneous program registration means and in correspondence with the programs registered in or canceled from the registration means.

U.S. Pat. No. 6,601,018 B1 issued Jul. 29, 2003 to Logan for AUTOMATIC TEST FRAMEWORK SYSTEM AND METHOD IN SOFTWARE COMPONENT TESTING discloses method and system aspects for test execution for software components within the context of an automatic test framework. The method includes reading an executable file of a component, executing a test case code generator automatically on the executable file, and generating a skeleton test suite as a base for an individualized test case of the component.

U.S. Pat. No. 7,181,382 B2 issued Feb. 20, 2007 to Shier et al. for SYSTEM AND METHOD FOR TESTING, SIMULATING, AND CONTROLLING COMPUTER SOFTWARE AND HARDWARE discloses providing an extensibility model to create device simulators. Provided, is a generalized framework for simulation of hardware devices controlled by software drivers with user and kernel mode programmability. In one embodiment, a framework provides a bi-directional communication channel that allows a test application in user address space of an operating system to communicate with a compute component operating kernel address space of the operating system.

Agile Testing, STAF/STAX tutorial, Automated test distribution, execution and reporting with STAF/STAX, Dec. 16, 2004 discloses how the use the STAF/STAX framework from IBM.

### SUMMARY OF THE INVENTION

An object of the present invention is the separation of the Test Script execution environment from the Test Execution environment. The invention describes a way of constructing test cases such that the Test Script sends commands to the Test Execution environment to run a test. The execution environment can be different operating systems platforms or the same platform. The tests are constructed such that they send the results back to the requester. In this way the remote Test Script execution environment can run tests on many diverse Test environments at the same time, and coordinate both the test execution and the results collection. Since results are returned, branches can be placed in the test script based on returned results.

Since the Test Script environment is separate from the execution environment, the testers do not have to become familiar with the diversity of test execution environments, and their test cases and development environment can remain stable, avoiding learning and debugging.

Another object of the present invention is to provide a method for creating a test framework used for testing operating system components in a cluster system. The method includes containing a master “driver” node (the automatic test system code is stored on this node) which assists in creating test cases and scenarios. STAF/STAX code available from IBM drive the tests. (Only the driver node contains the STAF/STAX code). The method further uses the dsh command to distribute execution of commands to one or more remote hosts. The dsh command distributes execution to the remote hosts through an external remote shell program (ex. AIX rsh, OpenSSH). Upon receiving output from the remote shell program, the dsh command intercepts each line of output from each remote host, stores it in memory, and then prepends the name of the remote host to each line of output. This eliminates installation of STAF/STAX on a cluster thus making it OS and hardware platform independent. The method further uses shared NFS space to store tests, utilities, and test results. Also, the method uses of GSA for off site test use.

The advantage of using this invention is that it would solve the problems of the prior art. An object of the present invention is the automation of test execution Automated Regression buckets can be created and made available for developers to test out new code.

Another object of the present invention is to provide a standard way of writing test cases and test buckets. The new testers can be more productive faster. There is no need to install /learnSTAF/STAX on all nodes, just the driver node. The present invention provides a “common language” that users can use to create standard library functions/utilities.

Another object of the present invention is the sharing of test cases and test functions. This allows test case/test bucket encapsulation and eliminates duplicated efforts that perform the same tests. If a single test case exists to perform some action, more time can be spent creating it. This tends to create higher quality test cases with the test cases (and buckets) maintained for its useful life.

Another object of the present invention is to reduce test bucket design time since tests are standardized and a library of available test cases is browsable.

Another object of the present invention is to automatically generate documentation for buckets and test cases thereby eliminating time spent in creating these documents by FVT (Functional Verification Test), as are done now. The result is that documentation is always current and the documentation is easy to create in other formats as needed.

Another object of the present invention is the shared pool of test machines and the ability to schedule bucket runs on test machines with different or same operating systems platforms. The shared machines will lead to lower overall test hardware cost. Also, developers can schedule unit testing.

Another object of the present invention is the standardization of reports which eliminates confusion and overhead of creating many different report types.

It is another object of the present invention to provide an automatic test system which serves as a test focal point in the lab. The automatic test system of the present invention can be the springboard from which we will move to Rational test tools. If the automatic test system of the present invention is the standard tool, moving to Rational will be simpler and quicker.

It is another object of the present invention to provide Automatic Defect Management. The automatic test system of the present invention can open defects as needed.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an automated cluster test system of the present invention:

FIG. 2 is a flowchart illustrating the execution flow of the system illustrated in FIG. 1;

FIG. 3 is a flowchart showing the flow of how the test database is populated;

FIG. 4 is an illustration of the run parameters of a test scenario of the present invention;

FIG. 5 illustrates a portion of one embodiment of the standard report of the invention showing the start and stop times of the execution flow of FIG. 2;

FIG. 6 illustrates a portion of one embodiment of the standard report of the invention showing the test cases that were run in the execution of the flow of FIG. 2;

FIG. 7 is an illustration a portion of one embodiment of the standard report of the invention showing the test node statistics used in the test flow of FIG. 2;

FIG. 8 is an illustration of a portion of one embodiment of the standard report of the invention showing the commands run in the test flow of FIG. 2; and

FIG. 9 is an illustration of a portion on one embodiment of the standard report of the invention and is an example of a failed test case.

The detailed description explains the preferred embodiment of the invention, together with advantages and features, by way of example with reference to the drawings.

### DETAILED DESCRIPTION OF THE INVENTION

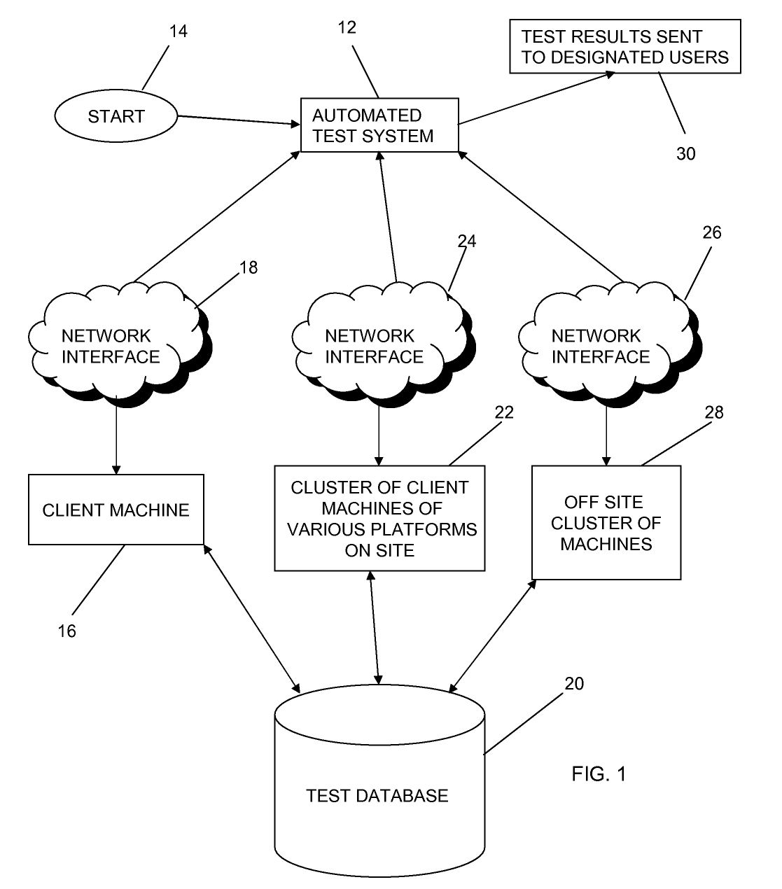

FIG. 1 illustrates the automatic test system of the present invention for evaluating the software, such as the Operating System (OS) and middleware of a cluster of machines. The Automated Test System 12 (sometimes referred to as RATS or RSCT Automated Test System) resides on a server. RSCT stands for Reliable Scalable Cluster Technology and is understood by those of skill in the art and will not be discussed further. The Automated Test System 12 is started at 14 to start a test or evaluation of the software on each machine of a cluster. The Automated Test System is code which is stored on a master driver node which assists in creating test cases and scenarios. The scenarios of test cases to be executed are referred to herein as buckets. The bucket is a collection of test cases executed under flow control and is what gets executed under the test cases. A bucket is the main driver of the test. Buckets are implemented in STAX XML format and a bucket can invoke another bucket. The specifications and parameters are assembled into a bucket for running tests on a particular machine or cluster and specified therein.

The Automated Test System 12 accesses a client machine 16 through a network interface 18. The client machine 16 receives the bucket for running the scenarios of tests from a test database 20 which has been established earlier. The database may be, for instance an NFS or a GSA mounted device. It will be understood that the NFS device is a standard machine for one site use, and GSA may be a Global Storage architecture device available from IBM for global access. It will also be under that the test database may be resident on the client machine or on the server where the Automated Test System 12 resides, as desired. Other configurations of the test database may be used, as will be understood by those skilled in the art.

The Automated Test System has access to a cluster of client machines 22 which may be of various platforms and on site through a network interface 24. The Automated Test System 12 has the parameters, such as passwords, to get by firewalls protecting the client machines. The Automated Test System also has access to any off site cluster of machines 26 through the network interface 28. After the test cases are run by the Automated Test System in accordance with the test buckets, the test results are sent to designated users 30. In one embodiment, the test results standard reports may be placed on the web, and web technology is used to make the standard test reports visible to everyone who has access to them through the web.

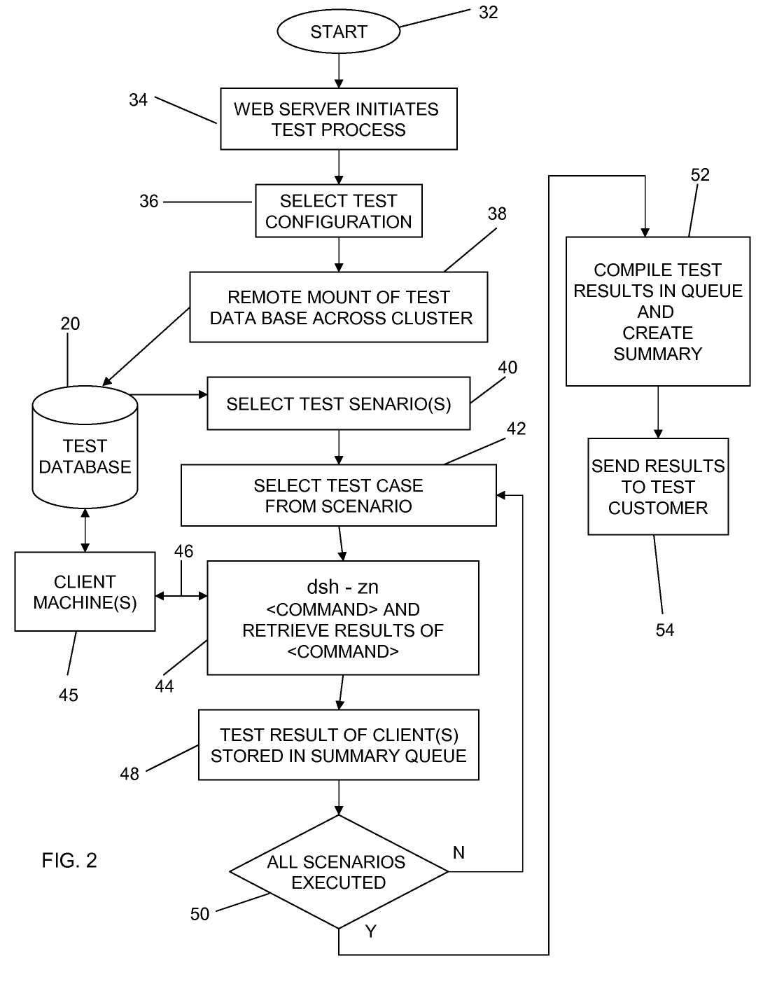

FIG. 2 is a flowchart illustrating the flow of the method of the Automated Test System of FIG. 1. At 32, the execution of a test is started. At 34, the test process is initiated by going through the web server. At 36, the test configuration is selected, as well as what set of machines the test will be conducted on. At 38, the Automated Test System issues a mount of either a NFS server on all of the machines in the test configuration, or acquire a GSA. At 40, test scenario(s) are selected to perform on the test configuration. The construct of the test scenarios, are the STAX XML functions. They contain all the logic and parameters needed to run. Imbedded in the logic, is a call to the specific test case. The Automated Test System 12 also has the ability to invoke the test case on a single node, or across nodes in parallel. At 42, the scenario calls the test case(s) from the test database 20.

At 44, each test case, uses a dsh −zn command This eliminates the need to have STAF/STAX installed on all client nodes. As is well understood, the dsh command is part of the UNIX operating system and is a function to remotely execute a command. As is known, the dsh command will not only distribute the command to any machine 45, but if the −z option is used, it will retrieve the results of the command from the machine 45 as shown at 46, as though it was invoked on the machine directly.

At 48, each test result is stored in a queue. At 50, a check is made to insure if until all individual test cases have been invoked. If not, the system returns to 42 to do the next test case. At 52, the individual test results, are now compiled, and stored in the TEST DATABASE 20, as a summary file. At 54, the summary file is now sent to any designated test customer.

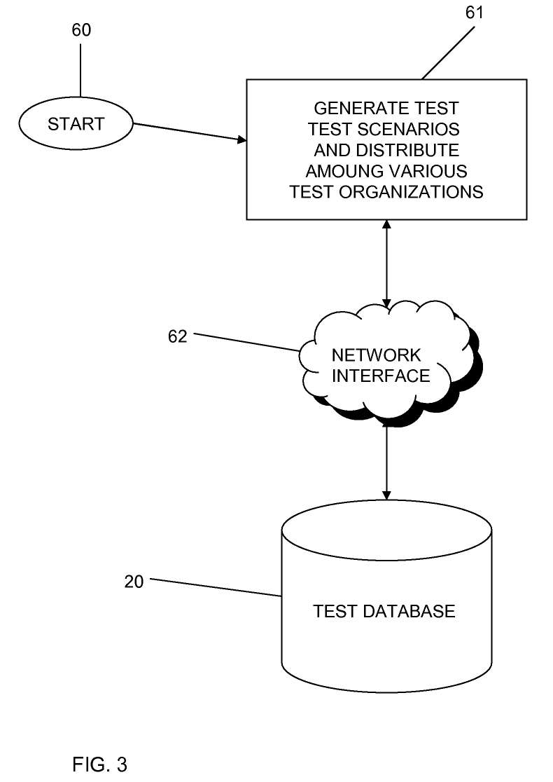

FIG. 3 illustrates a flowchart showing how test cases are created. The flow is started at 60. The test scenarios are generated at 61 and are menu driven by a system that will create, for each node in the RATS.machine_list, to be run in parallel. For each test case, the command “Execute test case ______” is established, and the test case name is filled in. This will create a scenario. In the test database 20 through a network interface 62.

Also simply copying an existing scenario and modifying the scenario is an option. The smallest unit of work should be small and self contained. It includes a test case name that will become part of all reports. The major element in this file is the execution, i.e. the actual command or script that will perform that small piece of work.

(example /RATS/tests/cases/CSM/Query list of nodes)
Run /RATS/bin/genMeta.py
Pipe output to a file located on NFS be sure it ends in .meta
Provide data for the fields in the .meta file as needed.

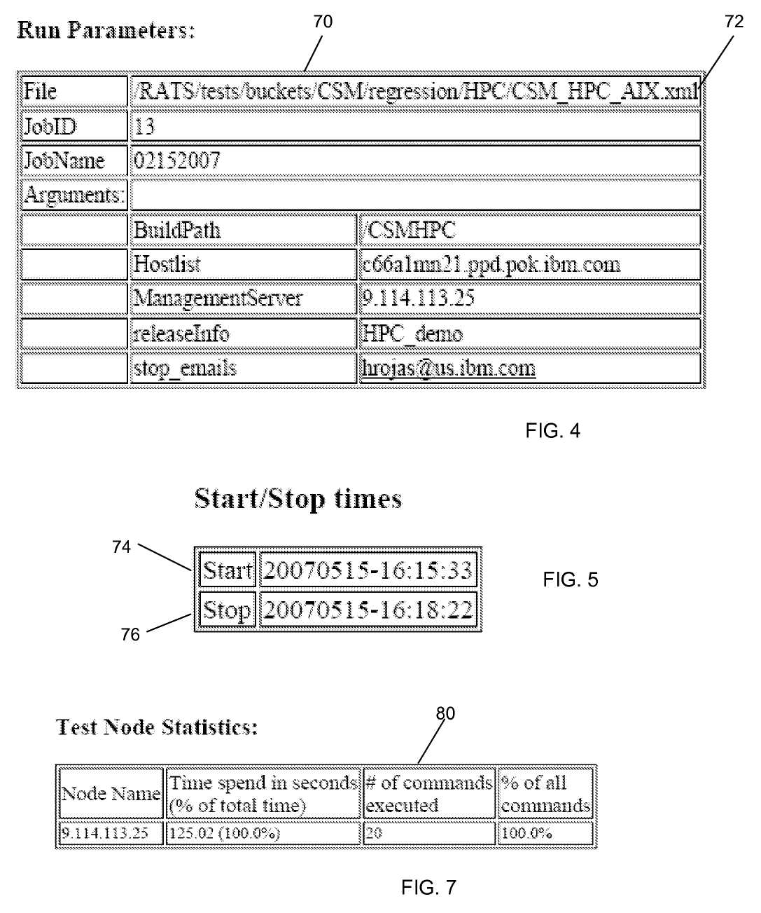

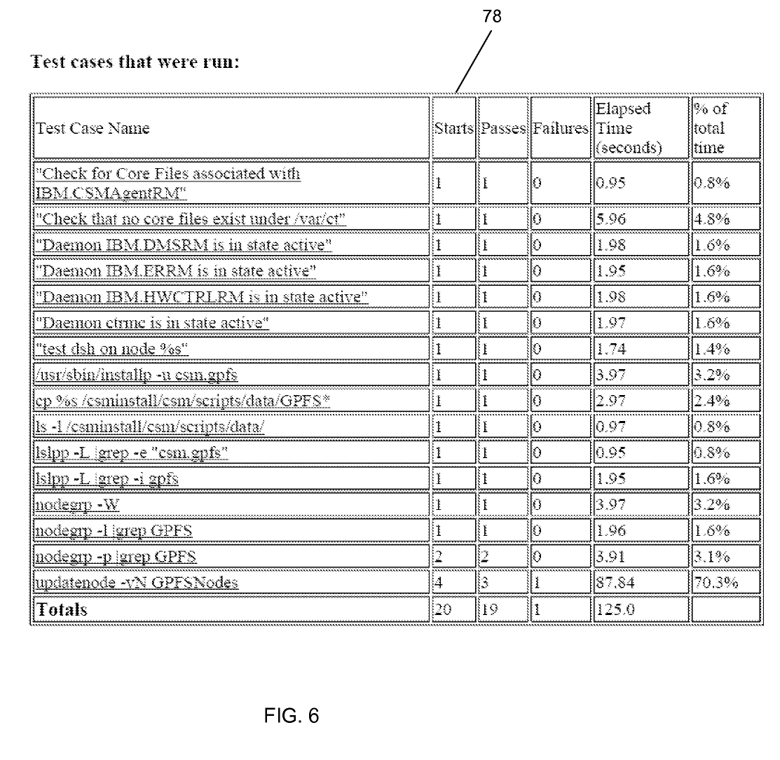

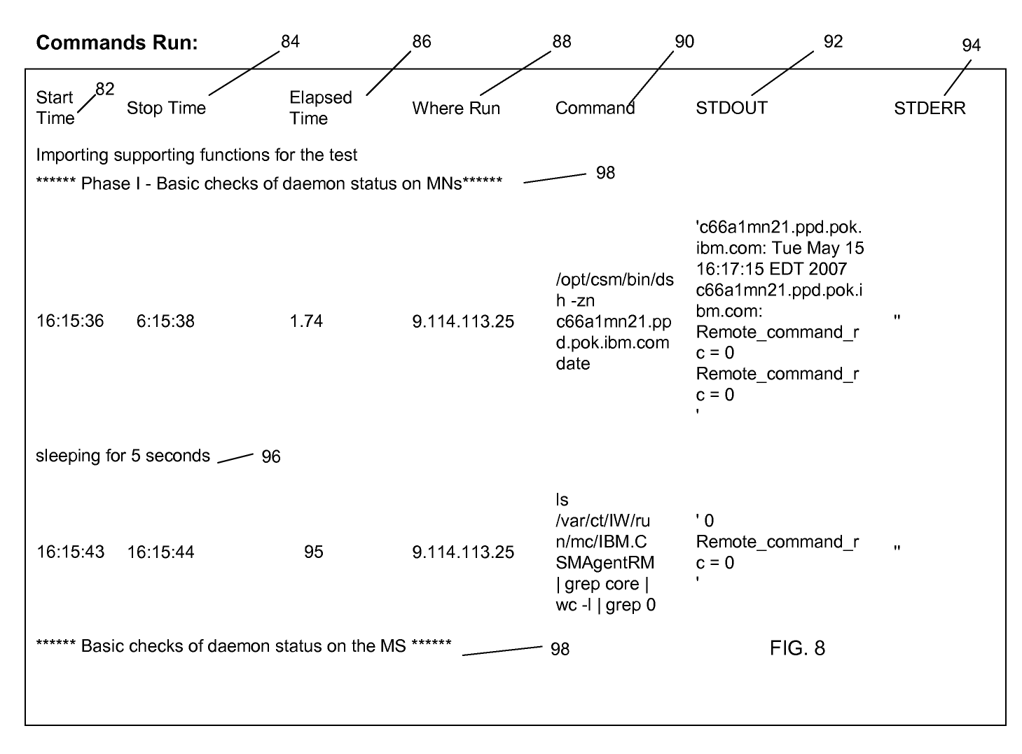

FIG. 4 is an illustration of the run parameters 70 defined in a scenario. It will be understood that the file name 72 defines where in the database 20 this test case is located. The other run parameters are well understood, and will not be discussed further. FIG. 5 is a portion of one embodiment of the standard report, and shows the start time 74 and stop times 76 of the entire scenario run. FIG. 6 is an illustration of a portion 78 of one embodiment of the standard report, and lists all test cases that were run for this scenario. FIG. 7 is an illustration of a portion of one embodiment of the standard report, and lists the statistics 80 of a test node run in this scenario. It will be understood that if more than one test node were included in this scenario, all of the statistics for all of the test nodes run would be listed. FIG. 8 is an illustration of a portion of one embodiment of the standard report of the present invention. The listing of FIG. 8 shows the start time 82, stop time 84, elapsed time 86, where run (node) 88, the command run 90, the standard output (STDOUT) 92, and standard error (STDERR) 94, if any, for this command. Other information is also shown, such as how long the processor was sleep 96, and checkpoints 98 in the test, as desired.

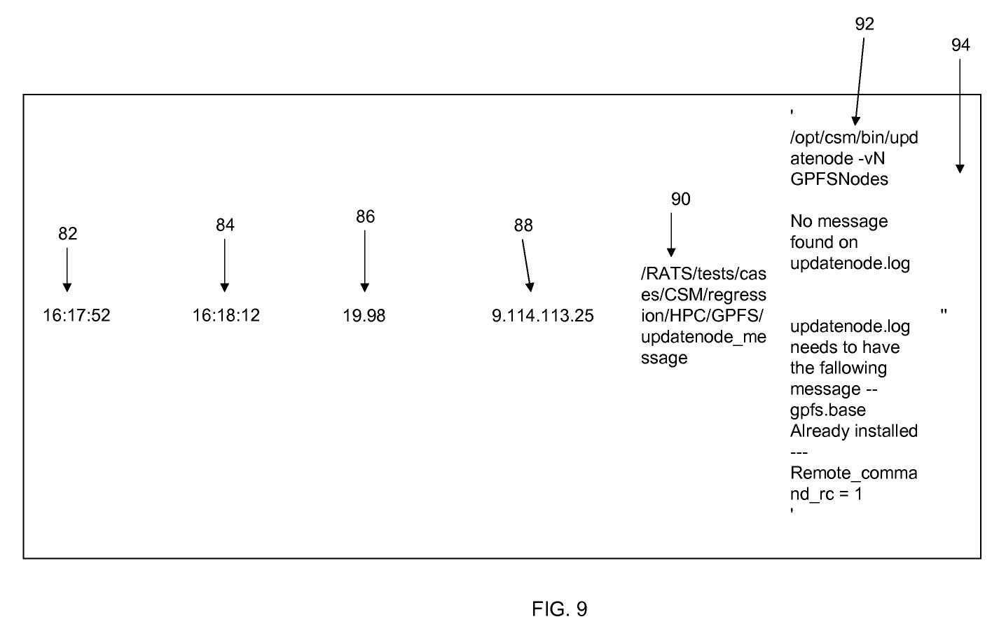

FIG. 9 is an illustration of a portion of the standard report and is an example of a failed test case. The data listings of FIG. 9 are numbered with the same reference numbers of FIG. 8 and have the same definitions.

While this was originally developed for Testing, it can be used in any environment where there is a controlling process that needs to control distributed resources, and will be most beneficial if the resources are heterogeneous.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An apparatus for testing software comprising:
a server;
a cluster of client machines connected to said server;
storage accessible by said server and said cluster of client machines, said storage for storing test cases for testing software on said client machines; and
a master driver on said server for assisting in creating said test cases stored in said storage, said master further issuing a command from said master driver to distribute execution of commands on one or more client machines in said cluster for executing said one or more of said test cases stored in said storage.

2. The apparatus of claim 1 wherein said master driver further retrieves results of said commands and comprises compiling individual test results for each machine executing commands distributed by said master driver.

3. The apparatus of claim 1 further comprising a function for sending said individual results in standard reports to designated test customers for display.

4. The apparatus of claim 1 wherein said master driver distributes a dsh command to one or more client machines in said cluster.

5. The apparatus of claim 4 wherein said master driver uses the −z option to retrieve the results of the command as though it was invoked on said server.

6. The apparatus of claims 1 wherein said storage is accessible on the web such that test customers may see the test cases and standard reports on the web.

7. The apparatus of claim 1 wherein said storage is on an NFS mounted or GSA mounted device.

8. In an apparatus for testing software including a server, a cluster of client machines connected to said server, and storage accessible by said server and said cluster of client machines, a method for testing software on said client machines comprising:
storing in said storage, test cases for testing software on said client machines; and
creating with the assistance of a master driver on said server, test cases for testing software;
storing in said storage, said test cases; and
issuing a command from said master driver to distribute execution of commands on one or more client machines in said cluster for executing said one or more of said test cases stored in said storage.

9. The method of claim 8 further comprising:
retrieving results of said commands; and
compiling individual test results for each machine executing commands distributed by said master driver.

10. The method of claim 8 further comprising sending said individual results in standard reports to designated test customers for display.

11. The method of claim 8 further comprising distributing a dsh command to one or more client machines in said cluster for distributing commands for executing said one or more of said test cases stored in said storage.

12. The method of claim 11 further comprising using the −z option to retrieve the results of the command as though it was invoked on said server.

13. The method of claims 8 further comprising making said storage accessible on the web such that test customers may see the test cases and standard reports on the web.

14. The method of claim 8 wherein said storage is on an NFS mounted or GSA mounted device.

15. A program product for use in an apparatus for testing software including a server, a cluster of client machines connected to said server, and storage accessible by said server and said cluster of client machines for testing software on said client machines, said program product comprising:
a computer readable medium having recorded therein computer readable program code for performing the method comprising:
storing in said storage, test cases for testing software on said client machines; and
creating with the assistance of a master driver on said server, test cases for testing software;
storing in said storage, said test cases; and
issuing a command from said master driver to distribute execution of commands on one or more client machines in said cluster for executing said one or more of said test cases stored in said storage.

16. The program product of claim 15 wherein said method further comprises:
retrieving results of said commands; and
compiling individual test results for each machine executing commands distributed by said master driver.

17. The program product of claim 15 wherein said method further comprises sending said individual results in standard reports to designated test customers for display.

18. The program product of claim 15 wherein said method further comprises distributing a dsh command to one or more client machines in said cluster for distributing commands for executing said one or more of said test cases stored in said storage.

19. The program product of claim 18 wherein said method further comprises using the −z option to retrieve the results of the command as though it was invoked on said server.

20. The program product of claims 15 wherein method further comprises making said storage accessible on the web such that test customers may see the test cases and standard reports on the web.
